(19) United States
(12) Patent Application Publication
(10) Pub. No.: US 2012/0091195 A1
(43) Pub. Date: Apr. 19, 2012

(54) LOSS PREVENTION SYSTEM WITH COVERT MARKS AND METHOD OF MANUFACTURE THEREOF

(75) Inventors: Edward Allen Gehrich, Terre Haute, IN (US); Matthew Stewart Lindsey, W. Terre Haute, IN (US); Anthony Carson New, Terre Haute, IN (US); Ed Proffitt, Brazil, IN (US)

(73) Assignees: SONY DADC US INC., Terra Haute, IN (US); SONY CORPORATION, Tokyo (JP)

(21) Appl. No.: 13/155,242

(22) Filed: Jun. 7, 2011

Related U.S. Application Data
(60) Provisional application No. 61/393,169, filed on Oct. 14, 2010.

(51) Int. Cl. G06K 5/00; G06K 19/06; B41M 3/14; G06K 19/00

(52) U.S. Cl. 235/375; 235/487; 235/491; 427/7

(57) ABSTRACT

A method of manufacture of a loss prevention system includes: providing a disc having a top planar surface; and applying an identification mark on the top planar surface, the identification mark containing covert security information.

### CROSS-REFERENCE TO RELATED APPLICATION

This application claims the benefit of U.S. Provisional Patent Application Ser. No. 61/393,169 filed Oct. 14, 2010, and the subject matter thereof is incorporated herein by reference thereto.

### TECHNICAL FIELD

The present invention relates generally to a loss prevention system and more particularly to a system for utilizing marks in a loss prevention system.

### BACKGROUND

The rapidly growing market of data storage, e.g. Blu-ray discs or Digital Versatile Discs is an integral facet of modern life. Digital content kiosks are becoming an increasingly popular means for displaying, marketing, and distributing digital media content. The multitude of digital content kiosks represents a large potential market opportunity for dispensing digital media. As the value of the Digital content increases with Blu-ray discs, video games, and emerging media such as Holographic Disc, theft of the Digital media becomes an increasing problem.

Anti-theft devices have unique attributes that have significant impacts on manufacturing integration, in that they must be generally rich in functionality and produced in high volumes at relatively low cost. There have been many approaches to addressing the advanced anti-theft requirements of digital content kiosks. Many industry road maps have identified significant gaps between the current anti-theft capability and the available supporting technologies. The limitations and issues with current technologies include increasing limited functionality, prohibitive manufacturing complexity, unreliability, and high cost.

As distribution systems evolve to incorporate more features with varied environmental needs, the pressure to push the technological envelope becomes increasingly challenging. More significantly, with the ever-increasing complexity, the potential risk of error increases greatly during manufacture.

In view of the ever-increasing commercial competitive pressures, along with growing consumer expectations and the diminishing opportunities for meaningful product differentiation in the marketplace, it is critical that answers be found for these problems. Additionally, the need to reduce costs, reduce production time, improve efficiencies and performance, and meet competitive pressures, adds an even greater urgency to the critical necessity for finding answers to these problems.

Thus, a need remains for more robust loss prevention systems and methods for manufacture. Solutions to these problems have been long sought but prior developments have not taught or suggested any solutions and, thus, solutions to these problems have long eluded those skilled in the art.

### DISCLOSURE OF THE INVENTION

The present invention provides a method of manufacture of a loss prevention system including: providing a disc having a top planar surface; and applying an identification mark on the top planar surface, the identification mark containing covert security information.

The present invention provides a loss prevention system, including: a disc having a top planar surface; and an identification mark formed on the top planar surface, the identification mark containing covert security information.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an isometric view of a loss prevention system in a first embodiment of the present invention.

FIG. 2 is a cutaway isometric view of a digital content kiosk for utilizing the loss prevention system of FIG. 1.

FIG. 3 is an isometric view of the loss prevention system along the line 3-3 of FIG. 1.

FIG. 4 is an isometric view of a loss prevention system in a second embodiment of the present invention.

FIG. 5 is an isometric view of the loss prevention system of FIG. 4 after a reception phase of manufacture.

FIG. 6 is an isometric view of the loss prevention system of FIG. 5 after a preparation phase of manufacture.

FIG. 7 is a top view of the loss prevention system of FIG. 6 after a print phase of manufacture.

FIG. 8 is an isometric view of the loss prevention system of FIG. 7 after a package phase of manufacture.

FIG. 9 is a flow chart of a method of manufacture of the loss prevention system of FIG. 1 in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes can be made without departing from the scope of the present invention.

In the following description, numerous specific details are given to provide a thorough understanding of the invention. However, it will be apparent that the invention can be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGS. Similarly, although the views in the drawings for ease of description generally show similar orientations, this depiction in the FIGS. is arbitrary for the most part. Generally, the invention can be operated in any orientation.

In addition, where multiple embodiments are disclosed and described having some features in common, for clarity and ease of illustration, description, and comprehension thereof, similar and like features from one to another will ordinarily be described with like reference numerals. The embodiments have been numbered first embodiment, second embodiment, etc. as a matter of descriptive convenience and are not intended to have any other significance or provide limitations for the present invention.

For expository purposes, the term “horizontal” as used herein is defined as a plane parallel to the plane or surface of the disc, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures. The term “on” means that there is direct contact between elements without having any intervening material.

The term applying as used herein includes printing, sticking, forming, or similar actions.

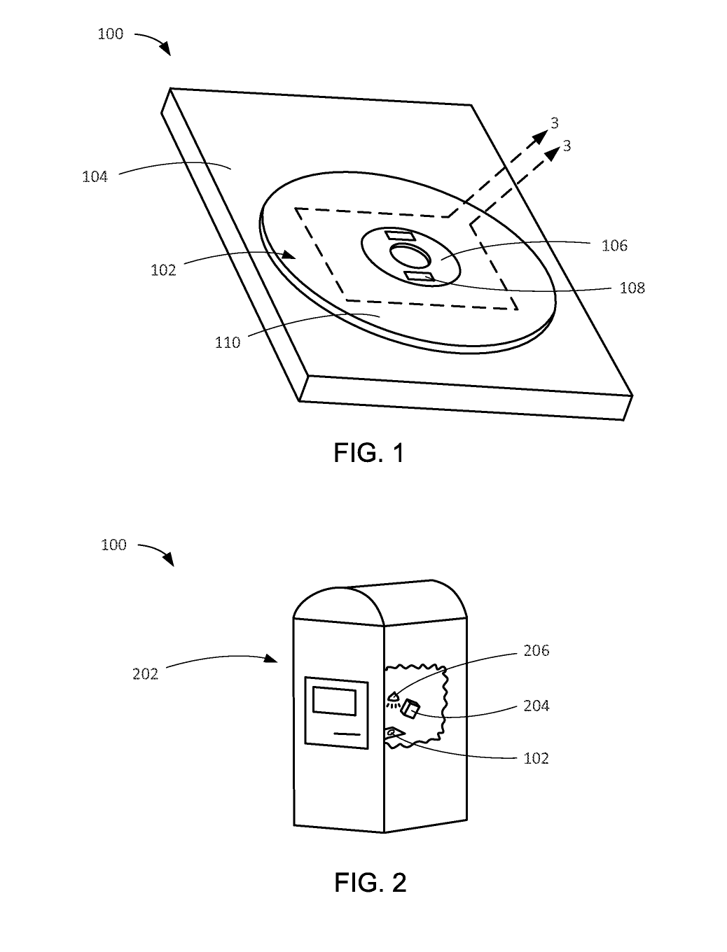

Referring now to FIG. 1, therein is shown an isometric view of a loss prevention system 100 in a first embodiment of the present invention. The loss prevention system 100 is shown having a digital storage medium depicted as a disc 102 and can be a Digital Versatile Disc, a Blu-ray, a Holographic Disc, a Compact Disc, or other digital storage medium.

The disc 102 is shown encased in a case 104 having protective properties to shield the disc 102 from external forces that can serve to degrade the digital information or the retrieval of digital information. The case 104 is shown providing access to information contained on an identification mark 106 by way of a window, or a cover that is transparent in an electromagnetic or photonic range in which the information on the identification mark 106 is accessed.

Overt information on the identification mark 106 is perceptible to the naked eye and can be information related to the disc 102. The overt information is shown as a barcode 108 however, the overt information can also be human readable text or a specially defined symbol or shape. The barcode 108 is defined as an encoded method of representing information about the digital information contained on the disc 102. The barcode 108 can be unique to each disc and can be utilized to track usage of the disc 102 and to catalog it as inventory.

A photo copy of the identification mark 106 will result in a reproduction substantially similar in appearance of what is visible to the naked eye of the identification mark 106 and can include the barcode 108; however, a photo copy will not include other covert information contained on the identification mark 106 that is not apparent to the naked eye. The identification mark 106 can be applied to a top planar surface 110 of the disc 102.

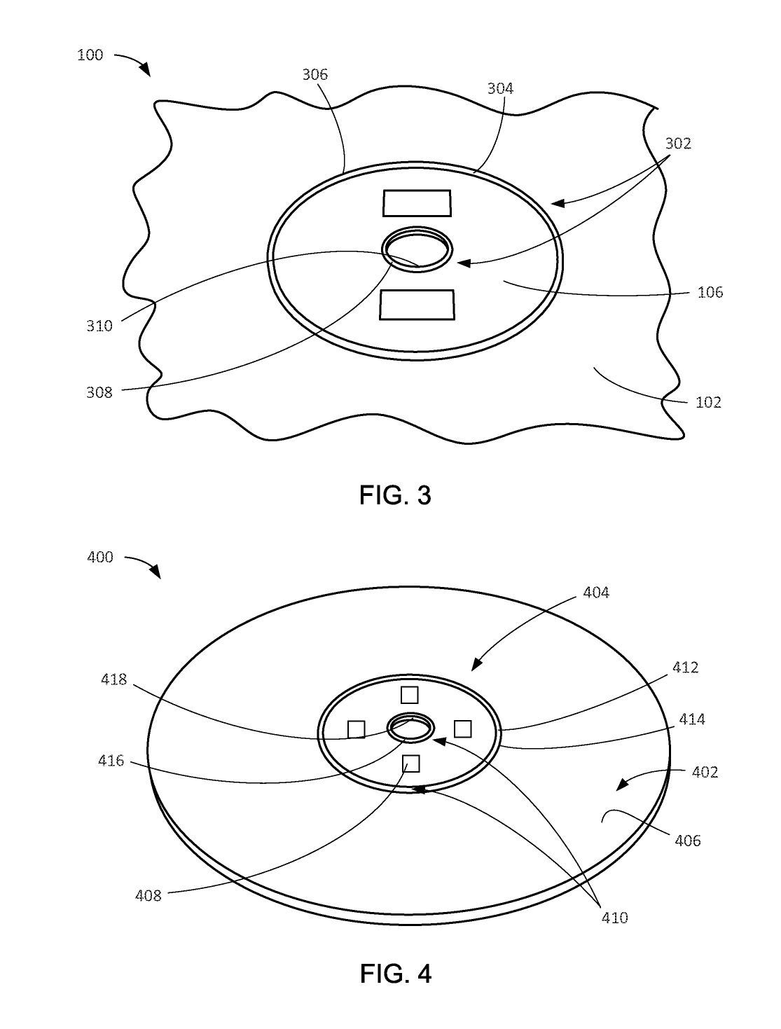

Referring now to FIG. 2, therein is shown a cutaway isometric view of a digital content kiosk 202 for utilizing the loss prevention system 100 of FIG. 1. The digital content kiosk 202 can exchange currency for the use or purchase of the disc 102, for example a Redbox™ kiosk. The digital content kiosk 202 is shown having an image sensor 204 and a covert light source 206. The image sensor 204 is defined as a means for perceiving light in the visible spectrum or light visible to the naked human eye. Examples of the image sensor 204 include a camera or a human visual sense.

It has been discovered that utilizing the image sensor 204 and the covert light source 206 can detect and process the covert security information contained on the disc 102. The image sensor 204 can utilize an image sensor illumination scheme to certify the identification mark 106 of FIG. 1 as genuine. Reducing the ability to detect the covert security information increases the robustness of the covert security information by reducing opportunities to reverse engineer the covert security information. For the purposes of this application, genuine is defined as the identification mark and disc as originally combined by an authorized entity.

Referring now to FIG. 3, therein is shown an isometric view of the loss prevention system 100 along the line 3-3 of FIG. 1. The loss prevention system 100 is shown having covert security information 302 imperceptible to the naked eye. The covert security information 302 is defined as information imperceptible by the naked eye that is stored as a single layer in or on the identification mark 106 and can be used to detect fraud, theft, or other malfeasance. The identification mark 106 may be comprised of multiple layers. The covert security information 302 is located on or in the identification mark 106.

The covert security information 302 may fluoresce when exposed to a predefined bandwidth of light. For the purposes of this application fluorescence is defined as an emission of photonic energy by a substance that has absorbed photonic energy. The emission may be the same or different wavelength. The covert light source 206 of FIG. 2 can emit a specified range of light wavelength which will cause a known fluorescence in the covert security information 302 and detectible by the image sensor 204 of FIG. 2. For the purposes of this application specified range of light wavelength is defined as a predefined bandwidth of photonic wavelength that will produce a predictable result when interacting with the covert security information 302 and that will be detectible by the image sensor 204 of FIG. 2.

The covert security information 302 can function regardless of viewing angle, angle of incidence of light directed at the covert security information, and regardless of magnification. For the purposes of this application a non-visible light wavelength or non-visible photonic spectrum is defined as a wavelength of light outside the visible spectrum of wavelengths.

It has been discovered that utilizing the covert security information 302 that can function regardless of viewing angle, angle of incidence of light directed at the covert security information, and regardless of magnification decreases costs and complexity of the loss prevention system 100. It has been further discovered that utilizing the covert security information 302 that can function regardless of viewing angle, angle of incidence of light directed at the covert security information 302, and regardless of magnification increases the versatility of placement of the covert security information 302 on the identification mark 106 enabling higher density information storage or increased versatility of design.

The covert security information 302 is perceptible to the image sensor 204 of FIG. 2 and will recognize the identification mark 106 as genuine and not a reproduction. The digital content kiosk 202 of FIG. 2 can also be backwards compatible and able to process overt information on identification marks that do not contain the covert security information 302. The covert security information 302 can be any design, symbol, shape, or configuration and is depicted as an outer ring 304 along an outer perimeter region 306 or an inner ring 308 along an inner perimeter region 310 of the identification mark 106.

It has been discovered that the covert security information 302 can be utilized to immediately detect theft, fraud, or other malfeasance concerning the disc 102. Immediate detection increases precision in extracting compensation for stolen goods as well as precision in recovering stolen goods.

It has also been discovered that containing the covert security information 302 configured as the outer ring 304, the inner ring 308, or a ring configuration (not shown) that is not limited to the outer perimeter region 306 or the inner perimeter region 310 decreases processing costs, increases the surface area and density of information that can be stored and allows for readability in any orientation. It has been further discovered that the in the outer ring 304, the inner ring 308, or a ring configuration (not shown) that is not limited to the outer perimeter region 306 or the inner perimeter region 310 utilizes space efficiently by placing security information along edges of the identification mark 106 where other information is not stored.

Referring now to FIG. 4, therein is shown an isometric view of a loss prevention system 400 in a second embodiment of the present invention. The loss prevention system 400 is shown having a disc 402 with an identification mark 404 printed on a top planar surface 406 of the disc 402.

The identification mark 404 is shown having barcodes 408 storing information that is unique to the disc 402. The identification mark 404 is further shown having covert security information 410 as an outer ring 412 along an outer perimeter region 414 of the identification mark 404 and as an inner ring 416 along an inner perimeter region 418 of the identification mark 404.

The identification mark 404 is printed on the disc 402 and is permanent or indelible. Indelible marks are defined as marks that cannot be removed. Further, the covert security information 410 on the identification mark 404 is not perceptible by the naked eye. A photo copy of the identification mark 404 will result in a reproduction of the barcodes 408 but not the covert security information 410.

It has been discovered that printing the identification mark with ink printed directly on the top planar surface 406 of the disc 402 reduces cost of manufacturing the disc 402 and allows for the increased availability of the covert security information 410 to be used in many diverse areas at many price points. Further, it has been discovered that the identification mark 404 can be printed to resemble an unsecure identification mark to the naked eye resulting in an inability to fully estimate the protection level of any given disc in circulation. Yet further, the printed identification mark 404 has been discovered to be indelible and eliminates the ability to lift and reapply the identification mark 404.

It has been discovered that the covert security information 410 can be utilized to immediately detect theft, fraud, or other malfeasance concerning the disc 402. Immediate detection increases precision in extracting compensation for stolen goods as well as precision in recovering stolen goods.

It has also been discovered that containing the covert security information 410 configured as the outer ring 412, the inner ring 416, or a ring configuration (not shown) that is not limited to the outer perimeter region 414 or the inner perimeter region 418 decreases processing costs, increases the surface area and density of information that can be stored and allows for readability in any orientation. It has been further discovered that the outer ring 412, the inner ring 416, or a ring configuration (not shown) that is not limited to the outer perimeter region 414 or the inner perimeter region 418 utilizes space efficiently by placing security information along edges of the identification mark 404 where other information is not stored.

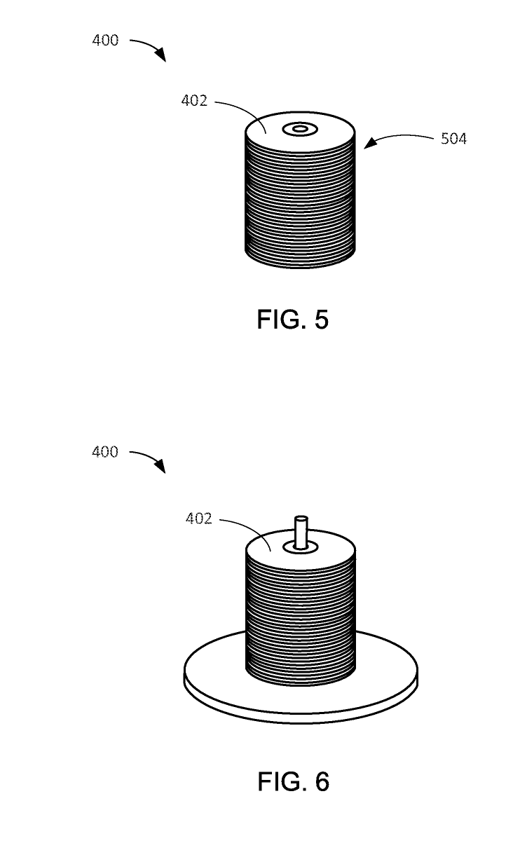

Referring now to FIG. 5, therein is shown an isometric view of the loss prevention system 400 of FIG. 4 after a reception phase of manufacture. The discs 402 are received in bulk packages 504 and can be received from multiple sources and transported for further processing.

Referring now to FIG. 6, therein is shown an isometric view of the loss prevention system 400 of FIG. 5 after a preparation phase of manufacture. The discs 402 have been unpacked, counted, organized, and staged for further processing. Orders are also correlated with the discs 402.

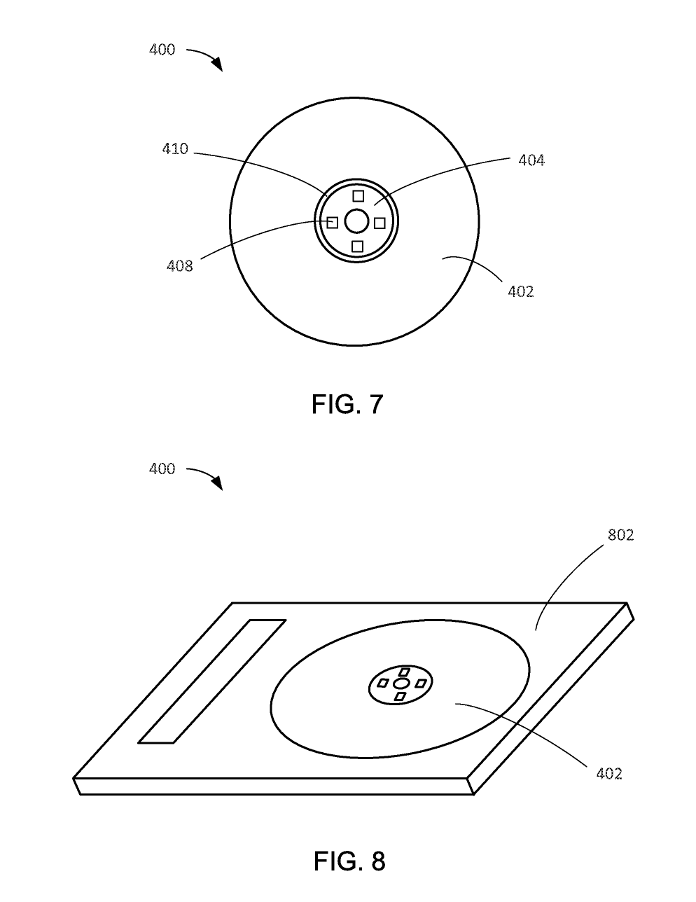

Referring now to FIG. 7, therein is shown a top view of the loss prevention system 400 of FIG. 6 after a print phase of manufacture. The identification mark 404 is shown printed on the disc 402.

The identification mark 404 can be printed on one side of the disc 402 using a two-step process in which the barcodes 408 are printed separately from the covert security information 410. The two-step process can have the physical characteristics of marks on a first printed portion. The two-step process can further have the physical characteristics of overlap between a first printed portion and a second printed portion.

The identification mark 404 can be printed on one side of the disc 402 using a one-step process in which the barcodes 408 are printed in the same process as the covert security information 410. The one-step process can have the physical characteristics of no tooling marks on the printed portion. The identification mark 404 can also be printed on both sides of the disc 402.

Referring now to FIG. 8, therein is shown an isometric view of the loss prevention system 400 of FIG. 7 after a package phase of manufacture. The disc 402 is shown placed into a case 802 to protect the digital media contained on the disc 402. The case 802 can be packaged in cartons and then shipped.

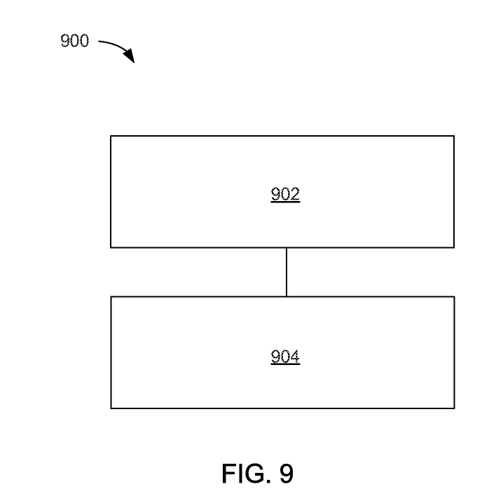

Referring now to FIG. 9, therein is shown a flow chart of a method 900 of manufacture of the loss prevention system 100 of FIG. 1 in a further embodiment of the present invention. The method 900 includes: providing a disc having a top planar surface in a block 902; and applying an identification mark on the top planar surface, the identification mark containing covert security information in a block 904.

Thus, it has been discovered that the covert security information of the present invention furnishes important and heretofore unknown and unavailable solutions, capabilities, and functional aspects for digital content distribution and manufacture. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of manufacture of a loss prevention system comprising:
providing a disc having a top planar surface; and
applying an identification mark on the top planar surface, the identification mark containing covert security information.

2. The method as claimed in claim 1 wherein applying the identification mark containing the covert security information includes applying the identification mark containing the covert security information to fluoresce to a specified range of light wavelength.

3. The method as claimed in claim 1 wherein applying the identification mark containing the covert security information includes printing the covert security information as a predefined pattern on the identification mark.

4. The method as claimed in claim 1 wherein applying the identification mark containing the covert security information includes printing ink directly on the top planar surface.

5. The method as claimed in claim 1 wherein applying the identification mark containing the covert security information includes applying the identification mark containing the covert security information reactive in a specified range of light wavelength.

6. An authentication operation of a loss prevention system comprising:
inserting a disc having an identification mark containing covert security information;
illuminating a covert light source for emitting a specified photonic spectrum; and
employing an image sensor for certifying the identification mark as genuine.

7. The operation as claimed in claim 6 wherein:
inserting the disc containing covert security information includes inserting the disc having covert security information to fluoresce to a specified range of light wavelength; and
employing the image sensor includes detecting fluorescence of the covert security information.

8. The operation as claimed in claim 6 wherein employing the image sensor includes detecting the covert security information and certifying the disc as genuine.

9. The operation as claimed in claim 6 wherein employing the image sensor includes detecting overt information on the disc.

10. The operation as claimed in claim 6 wherein employing the image sensor includes comparing overt information and the covert security information to certify the disc as genuine.

11. A loss prevention system comprising:
a disc having a top planar surface; and
an identification mark formed on the top planar surface, the identification mark containing covert security information.

12. The system as claimed in claim 11 wherein the covert security information fluoresces in reaction to a specified range of light wavelength.

13. The system as claimed in claim 11 wherein the covert security information is a predefined pattern on the identification mark.

14. The system as claimed in claim 11 wherein the identification mark is ink printed directly on top planar surface.

15. The system as claimed in claim 11 wherein the covert security information is reactive in a specified range of light wavelength.

16. A loss prevention authentication system comprising:
a disc containing covert security information;
a covert light source for emitting a specified photonic spectrum; and
an image sensor for certifying the identification mark as genuine.

17. The system as claimed in claim 16 wherein:
the covert security information fluoresces to a specified range of light wavelength; and
the image sensor detects fluorescence of the covert security information.

18. The system as claimed in claim 16 wherein the image sensor detects the covert security information and certifies the disc as genuine.

19. The system as claimed in claim 16 wherein the image sensor detects overt information on the disc.

20. The system as claimed in claim 16 wherein the image sensor compares overt information and the covert security information to certify the disc as genuine.
